(19) United States
(12) Patent Application Publication
(10) Pub. No.: US 2009/0072464 A1
(43) Pub. Date: Mar. 19, 2009

(54) Double-sided cutting board

(76) Inventor: Alon Ben Ishai, Brooklyn, NY (US)

Correspondence Address: Steven Horowitz;Counselor At Law, Suite 700, 295 Madison Avenue, New York, NY, 10017, US

(21) Appl. No.: 11/901,902

(22) Filed: Sep. 18, 2007

(51) Int. Cl. A47J 43/00; B26D 3/00

(52) U.S. Cl. 269/289 R; 83/13

(57) ABSTRACT

A double-sided cutting board prevents mixing of flavors and cross-contamination, comprising a first flat board made of material selected form the group consisting of wood and bamboo and forming a first working surface designated for cutting one type of food, a second flat board made of plastic and forming a second working surface for cutting a second type of food, the first working surface and the second working surface lying in parallel planes, the first flat board and the second flat board held in fixed and spaced relation to one another by a rigid rim that extends around an outer surface of the cutting board. The plastic board may be for cutting fish and meat whereas the bamboo board can be used for cutting vegetables. When one wants to sharpen the knife blades, the bamboo board can be used such as for cutting meat.

### FIELD OF THE INVENTION

The field of this invention is cutting boards, and more particularly, cutting boards that are versatile enough to accommodate multiple types of food types.

### BACKGROUND OF THE INVENTION AND DISCUSSION OF THE PRIOR ART

Storage space in a kitchen is a valuable commodity. Therefore, any kitchen utensil or implement that can combine the functions of multiple utensils or implements or else can multiple the effectiveness or working surfaces of a single implement or utensil is desirable in the kitchen.

Along with maximizing storage space, minimizing the effort and expense and time of cleaning kitchen implements and utensils is another key objective in making efficient use of the kitchen. Consequently, any kitchen utensil or implement that can combine the functions of multiple utensils or implements or else can multiple the effectiveness or working surfaces of a single implement or utensil not only saves storage space but also minimizes the time, effort and cost of cleaning the kitchen utensils.

Cutting boards tend to occupy a significant amount of space in the kitchen since they have relatively large working surfaces. This is necessary because of the size of the meat or other food being cut, or the length of the knife doing the cutting.

In addition, cutting boards are used for a variety of foods—for cutting meats, fish and for cutting vegetables and herbs. The problem is that consumers have become more and more careful about the health effects of cross-contamination from the transfer of bacteria from one food—such as meats, fowl and fish, including raw fish, i.e. sushi. Due to the space saving and cost and tine of cleaning, most kitchens have only one cutting board, which would be used for the whole variety of food types. This can result in the bacteria from one type of food permeating the other type of food that is subsequently cut on the same cutting board.

Another problem is the mixing of flavors and odors. A wood cutting board used for cutting fish will absorb the odors of the fish and one may not ant those odors in other foods. Similarly, a cutting board used for cutting onions or garlic may absorb the flavor of the herbs and transfer that flavor to the fish or other food that you subsequently use the cutting board for. This may be particularly undesirable depending on the food type involved.

Another issue affecting the efficient use of multiple work surfaces for cutting boards is food separation for reasons other than health and taste. Various dietary customs and/or religious laws mandate the separation of meat and dairy or other non-meat products from one another.

Cutting boards tend to be made of wood or plastic, each having certain advantages and disadvantages. Although plastic will not absorb flavors like wood, the wood is better for keeping the knife blade sharp.

Another problem is that cutting boards tend to slip because of the greasy environment that they are placed on. When cutting meat or other foods with very sharp knives, the fact that the cutting board can slip from position with food on it poses a serious risk to the user.

Professional workers in commercial kitchens do not have time to cut one type of food on a working surface of one cutting board and either wash off the flavors and odors from that type of food or else pull out a separate second cutting board for cutting a different type of food.

Consequently, there is a compelling need for a cutting board that can accommodate a multiplicity of food types having a variety of flavors, and one that can safely be used without cross-contamination. Furthermore, there is a need for a cutting board that accommodates in one cutting board the ability to cut meat and non-meat products without violating customs, laws and/or practices mandating separation of these foods.

### SUMMARY OF THE PRESENT INVENTION

In one aspect of the present invention, there is presented a double-sided cutting board, comprising a first board made of material selected from the group consisting of wood and bamboo, the first board having a smooth and flat first working surface designated for cutting a first type of food, a second board made of plastic and having a smooth and flat second working surface for cutting a second type of food, the first working surface and the second working surface lying in parallel planes, the first board and the second board held in fixed and spaced relation to one another by a rigid rim that extends around an outer surface of the cutting board.

In a further aspect of the invention, there is presented a method of cutting food, comprising (1) providing a double-sided cutting board, the cutting board including a first board made of material selected form the group consisting of wood and bamboo, the first board having a smooth and flat first working surface designated for cutting one type of food, a second board made of plastic and having a smooth and flat second working surface for cutting a second type of food, the first working surface and the second working surface lying in parallel planes, the first board and the second board held in fixed and spaced relation to one another by a rigid rim that extends around an outer surface of the cutting board, (2) cutting a first type of food on the first working surface, and (3) cutting a second type of food on the second working surface.

In a further aspect of the present invention, there is presented A method of cutting food, comprising (1) setting down a double-sided cutting board on a surface, the cutting board including a first board made of material selected form the group consisting of wood and bamboo, the first board having a smooth and flat first working surface designated for cutting a first type of food, a second board made of plastic and having a smooth and flat second working surface for cutting a second type of food, the first working surface and the second working surface lying in parallel planes, the first board and the second board held in fixed and spaced relation to one another by a rigid rim that extends around an outer surface of the cutting board, (2) cutting a first type of food on the first working surface, and (3) cutting a second type of food on the second working surface.

These and other features, aspects and advantages of the present invention will become better understood with reference to the following drawings, descriptions and claims.

### OBJECTS AND ADVANTAGES

The following important objects and advantages of the present invention are:

(1) to provide a cutting board that can be used on two sides;

(2) to provide a cutting board that saves storage space;

(3) to provide a cutting board that avoids cross-contamination;

(4) that provide a cutting board that avoids mixing of flavors between different foods being cut thereon;

(5) to provide a cutting board that is specially designed for the cutting of both meats and vegetables and other food types;

(6) to provide a single cutting board having separate cutting surfaces for different foods so that individuals who separate meat from dairy or other foods for either religious or dietary reasons can use the cutting board for cutting both kinds of foods;

(7) to provide a cutting board that reduces the amount of cleaning work needed for cleaning all kitchen cutting implements;

(8) to provide a cutting board that doubles the working surface of the cutting board in one's kitchen without appreciably increasing the storage space needed;

(9) to provide a double-sided cutting board that is safer to use when cutting a wide variety of food types that should remain separate;

(10) to provide a cutting board that can safely and efficiently be used for cutting herbs, vegetables, meat fish and other foods; and

(11) to provide a cutting board that overcomes the disadvantages of the prior art.

These and other objects and advantages are appreciated from the background of the invention and discussion of the prior art, the brief description of the drawings, the detailed description of the exemplary embodiment and from the drawings and claims.

### BRIEF DESCRIPTION OF THE DRAWINGS

FIG. 1 is a perspective view of the double-sided cutting board of the present invention;

FIG. 2 is a front view thereof;

FIG. 3 is a right side view thereof;

FIG. 4 is a rear side view thereof;

FIG. 5 is a left view thereof;

FIG. 6 is a top view thereof; and

FIG. 7 is a bottom view thereof

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a double-sided cutting board that is used to cut a wide variety of food types in the kitchen. One side of the cutting board is made of a bamboo or wood and the other side is made of plastic.

In contrast to the prior art, the double-sided cutting board of the present invention has two different working surfaces that are separated from one another. Consequently, multiple food types can be cut without transferring the flavor, odor or any bacteria from one type to the other. Furthermore, the particular working surface that the user selects to cut food on can be chosen based on which material is suitable for the food to be cut. In contrast to the prior art, the two working surfaces appear in a single cutting board so only one cutting board has to be purchased, has to be cleaned and has to be stored.

The apparatus of the present invention will now be described by reference to the accompanying drawings. The double-sided cutting board of the present invention has been assigned reference numeral 10. Other elements have been assigned the reference numerals referred to below.

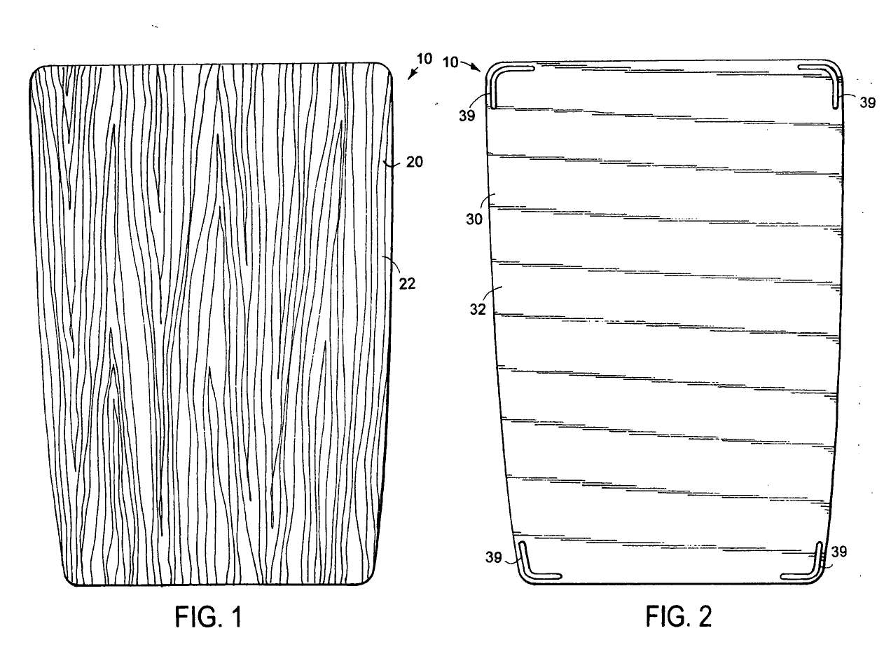

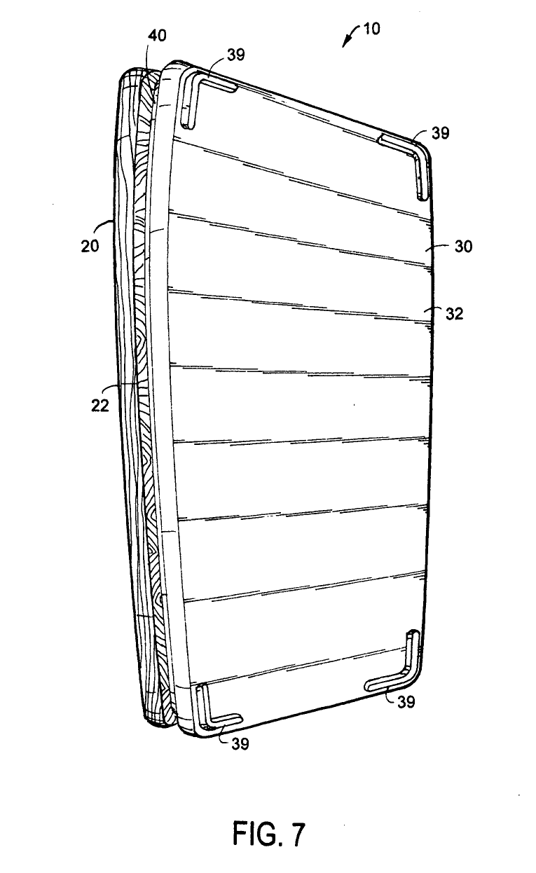

As seen from FIGS. 1-7, double-sided cutting board 10 comprises a first flat board 20 made of material selected form the group consisting of wood and bamboo. The ideal material for first board 20 is bamboo since it is resilient, is stronger than maple, is an attractive wood, grows very quickly (whereas a tree takes much longer to grow) and is highly replenishable so it is easily available.

First board 20 forms a smooth and flat first working surface 22 which may be designated for cutting one type of food and not all types of food. For example, when cutting meat one may want to sharpen the knife blade on a wood or bamboo working surface.

A second board 30 is made of plastic and forms a smooth and flat second working surface 32 for cutting a second type of food, for example herbs and vegetables such as onions, garlic etc. where odors and flavors should be segregated from other foods that need to be cut. The plastic of second board 30 may be polypropylene or other durable, odor resistant and rigid plastics. Polypropylene used in second board 30 does not absorb bacteria. It also resists deep scratches and can be used to keep knives sharp.

First working surface 22 and second working surface 32 lie in parallel planes. This is because first flat board 20 and second flat board 30 are held in fixed and spaced relation to one another by a rigid rim 40 that extends around an outer surface of the cutting board 10. Basically, the cutting board 10 may be hollow between the first cutting board 20 and the second cutting board 30 at least inside of rim 40. Rim 40 may be made from any suitable rigid and durable material such as metal. Rigid rim 40 may extend around the cutting board at or within half an inch of the perimeter of the cutting board 10. Typically, a first groove (not shown) is made in first flat board 10 near its perimeter and a similar second groove (not shown) is made in second flat board 30 near its perimeter. The top and bottom of rigid rim 40 sits in these grooves o securely hold first and second flat boards 20, 30 together in a fixed position durably and spaced apart from one another.

Cutting board 10 has a built-in feature that prevents slippage. Second flat board 30 has four plastic silicone legs 39 projecting therefrom near corners of said second flat board 30. These legs 39 may project outward for only a small distance, for example less than 2 millimeters. Accordingly, they are effective in preventing the cutting board 10 from slipping during critical dangerous moments of use with sharp knives yet the legs 39 do not appreciably increase the necessary storage space when cutting board 10 is stored.

As can be appreciated from FIGS. 1-7, and in particular FIGS. 1-2, the first working surface 22 and the second working surface 32 may have similar shapes. For example both may be trapezoidal and have a pair of short parallel sides and a pair of longer non-parallel sides, wherein the longer non-parallel sides are curved

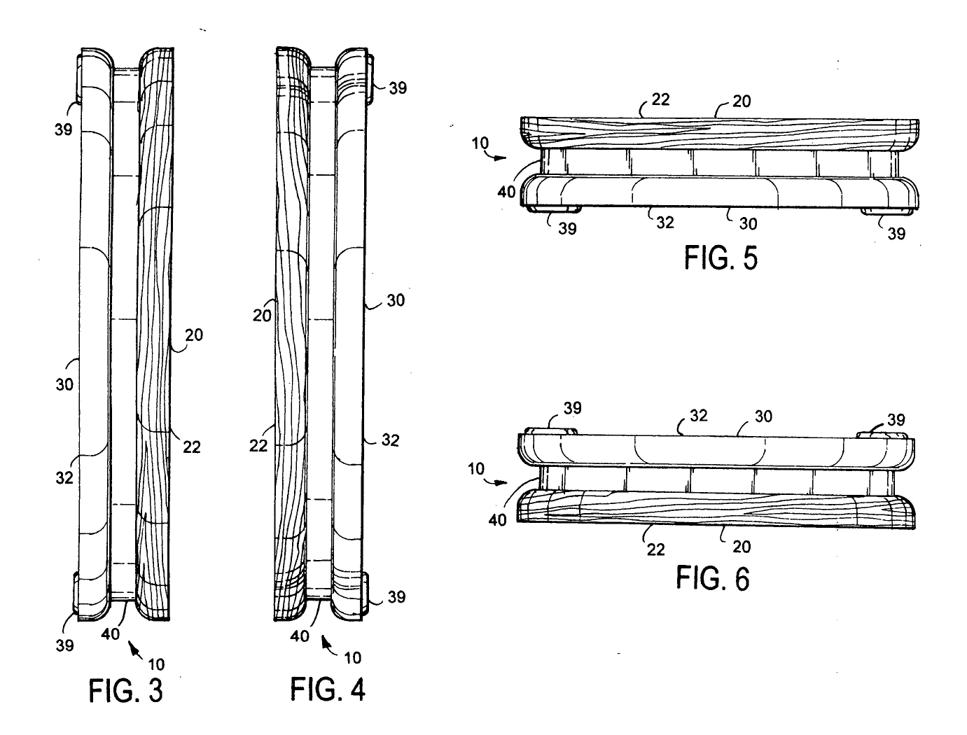

As can best be appreciated from observing FIGS. 1-7, in particular, FIGS. 3-6, an additional feature in cutting board 10 is that each of the four sides of the first flat board 20 and each of the four sides of the second flat board 30 may be beveled inward. Besides enhances the aesthetic appearance of the board 10, this feature serves to distance small pieces of food and grease from the working surfaces 22, 32.

The term “substantially trapezoidal” shall mean that the longer sides of the trapezoid may be curved. In this regard, working surfaces 22, 32 may be said to be substantially trapezoidal.

For the purposes of this patent application, the phrases “first type of food” and a “second type of food” shall be premised on dividing food into the following food types: (i) meat and fowl, (ii) fish, (iii) vegetables and herbs (iv) cheeses and other dairy products and (v) other types such as pasta. However, in other embodiments, these phrases can refer to any food type division that the user of the present invention chooses to make for practical reasons relating to the separation of foods. For example, if the user wishes to separate onions from other vegetables, onions can be considered a first food type and carrots and other vegetables can be considered a second food type.

The present invention can also be characterized as a method of cutting food, comprising (1) providing a double-sided cutting board, the cutting board including a first board made of material selected form the group consisting of wood and bamboo, the first board having a smooth and flat first working surface designated for cutting one type of food, a second board made of plastic and having a smooth and flat second working surface for cutting a second type of food, the first working surface and the second working surface lying in parallel planes, the first flat board and the second flat board held in fixed and spaced relation to one another by a rigid rim that extends around an outer surface of the cutting board, (2) cutting one type of food on the first working surface, and (3) cutting a second type of food on the second working surface.

An additional method of the present invention for cutting food comprises (1) setting down a double-sided cutting board on a stable surface in the kitchen, the cutting board including a first board made of material selected form the group consisting of wood and bamboo, the first board having a smooth and flat first working surface designated for cutting one type of food, a second board made of plastic and having a smooth and flat second working surface for cutting a second type of food, the first working surface and the second working surface lying in parallel planes, the first flat board and the second flat board held in fixed and spaced relation to one another by a rigid rim that extends around an outer surface of the cutting board, (2) cutting one type of food on the first working surface, and (3) cutting a second type of food on the second working surface.

It is to be understood that while the apparatus and method of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

We claim:

1. A double-sided cutting board, comprising:
a first board made of material selected from the group consisting of wood and bamboo, the first board having a smooth and flat first working surface designated for cutting a first type of food,
a second board made of plastic and having a smooth and flat second working surface for cutting a second type of food, the first working surface and the second working surface lying in parallel planes,
the first board and the second board held in fixed and spaced relation to one another by a rigid rim that extends around an outer surface of the cutting board.

2. The cutting board of claim 1, wherein the second flat board has four plastic silicone legs projecting therefrom near corners of said second board.

3. The cutting board of claim 1, wherein the first working surface and the second working surface have similar shapes.

4. The cutting board of claim 1, wherein each side of the first board and each side of the second board are beveled inward.

5. The cutting board of claim 1, wherein the rigid rim extends around the cutting board at or within half an inch of a perimeter of the cutting board.

6. The cutting board of claim 1, wherein the first working surface and the second working surface are each trapezoidal and have a pair of short parallel sides and a pair of longer non-parallel sides wherein the longer non-parallel sides are curved.

7. A method of cutting food, comprising:
(1) providing a double-sided cutting board, the cutting board including a first board made of material selected form the group consisting of wood and bamboo, the first board having a smooth and flat first working surface designated for cutting one type of food, a second board made of plastic and having a smooth and flat second working surface for cutting a second type of food, the first working surface and the second working surface lying in parallel planes, the first board and the second board held in fixed and spaced relation to one another by a rigid rim that extends around an outer surface of the cutting board,
(2) cutting a first type of food on the first working surface, and
(3) cutting a second type of food on the second working surface.

8. The method of claim 7, wherein the second board has four plastic silicone legs projecting therefrom near corners of said second flat board.

9. The method of claim 7, wherein the first working surface and the second working surface have similar shapes.

10. The method of claim 7, wherein each side of the first board and each side of the second board are beveled inward.

11. The method of claim 7, wherein the rigid rim extends around the cutting board at or within half an inch of a perimeter of the cutting board.

12. The method of claim 7, wherein the first working surface and the second working surface are each trapezoidal and have a pair of short parallel sides and a pair of longer non-parallel sides, wherein the longer non-parallel sides are curved.

13. A method of cutting food, comprising:
(1) setting down a double-sided cutting board on a surface, the cutting board including a first board made of material selected form the group consisting of wood and bamboo, the first board having a smooth and flat first working surface designated for cutting a first type of food, a second board made of plastic and having a smooth and flat second working surface for cutting a second type of food, the first working surface and the second working surface lying in parallel planes, the first board and the second board held in fixed and spaced relation to one another by a rigid rim that extends around an outer surface of the cutting board,
(2) cutting a first type of food on the first working surface, and
(3) cutting a second type of food on the second working surface.
